(19) United States
(12) Patent Application Publication
(10) Pub. No.: US 2011/0167793 A1
(43) Pub. Date: Jul. 14, 2011

(54) HYBRID ROCKET USING CATALYTIC DECOMPOSITION OF OXIDIZER

(75) Inventors: Sejin KWON, Daejeon (KR); Sungyong AN, Daejeon (KR); Jungkun JIN, Daejeon (KR); Eunsang JUNG, Daejeon (KR)

(73) Assignee: KOREA ADVANCED INSTITUTE OF SCIENCE AND TECHNOLOGY, Daejeon (KR)

(21) Appl. No.: 12/885,940

(22) Filed: Sep. 20, 2010

(30) Foreign Application Priority Data
Jan. 11, 2010 (KR) 10-2010-0002219

(51) Int. Cl. F02K 9/72

(52) U.S. Cl. 60/251

(57) ABSTRACT

Provided is a hybrid rocket using catalytic decomposition of oxidizer, which generates thrust by injecting high temperature oxygen and steam formed by catalytic decomposing liquid oxidizer into solid fuel and thereby auto igniting and combusting the solid fuel without a separate igniter. The hybrid rocket using catalytic decomposition of an oxidizer, including: a liquid phase oxidizer (0); a solid phase fuel (100) formed with a combustion chamber in an inside thereof, the combustion chamber passing through the solid fuel from one side to the other side so as to allow the oxidizer (0) flowing therein; a catalytic reactor (200) filled with a catalyst (220) for catalytically reacting the oxidizer (0), and introducing the oxidizer (0) through one side thereof and discharging the oxidizer (0) catalytically reacted through the catalyst (220) through the other side thereof; a combustor (300) formed with a space for inserting the solid fuel (100) therein, and introducing high temperature oxygen and steam in an inside thereof through one side thereof connected with the other side of the catalytic reactor (200), reacting them with the solid fuel (100) and discharging a combustion gas through the other side thereof; and a nozzle (400) connected with the other side of the combustor (300) to accelerate the combustion gas produced in the combustor (300) and discharge the combustion gas to the other side of the nozzle (400).

### CROSS-REFERENCE(S) TO RELATED APPLICATIONS

The present invention claims priority of Korean Patent Application No. 10-2010-0002219, filed on Jan. 11, 2010, which is incorporated herein by reference.

### BACKGROUND OF THE INVENTION

1. Field of the Invention

The present invention relates to a hybrid rocket using liquid oxidizer and solid fuel; and, more particularly, to a hybrid rocket using catalytic decomposition of oxidizer, which generates thrust by injecting high temperature oxygen and steam formed by catalytic decomposing liquid oxidizer into solid fuel and thereby auto igniting and combusting the solid fuel without a separate igniter.

2. Description of Related Art

In artificial satellites and rocket launchers, an engine is the sole device that generates thrust required for movement in space. A liquid rocket engine using chemical method is divided into a monopropellant type that employs one kind of propellant and a bipropellant type that obtains thrust by combusting fuel and oxidizer.

The bipropellant type rocket, compared to the monopropellant type, has an advantage that it has a specific impulse obtainable per unit flow rate of propellant, which is two times greater than that of the monopropellant type, but has disadvantages that it further requires various valves, propellant lines and a propellant tank and the system thus becomes heavy and complex and requires high technology.

A hybrid rocket is the type in that the two types of the liquid rocket and the solid rocket are united, and employs combination of liquid oxidizer and solid fuel. More specifically, it is the type of injecting the liquid oxidizer into the solid fuel to carry out combustion, and the solid fuel is filled in a rear portion of the oxidizer and is combusted to generate the thrust only when the liquid oxidizer is injected.

The hybrid rocket has a systematic simplicity that is second to the monopropellant rocket engine since only an oxidizer injection system is required, and is able to obtain high specific impulse like the bipropellant rocket that obtains the thrust after combustion of the fuel and the oxidizer.

The existing hybrid rocket employs oxygen (O₂) as the oxidizer, and in this case there is a problem in that ignition with a separate igniter is required simultaneous with the supply of the oxidizer to the fuel. That is, this hybrid rocket requires a separate igniter for ignition, and has generally employed a small bipropellant igniter, a small solid propellant igniter and an ignition using a torch.

These ignition methods have been used stably, but have disadvantages that re-ignition is not easy and instant ignition is also not easy since a fixed ignition process is required. Accordingly, since the hybrid rocket can be used in a continuous operation mode which uses one time ignition as shown in the left graph of FIG. 4 but is hard to be utilized in a pulse operation mode in which many re-ignitions are required as shown in the right graph of FIG. 4, the hybrid rocket has been recognized that it is suitable for the use of flight sustainment of a flight vehicle rather than the purpose of attitude control. Therefore, there is urgently required a hybrid rocket capable of carrying out the re-ignition stably and quickly for the purpose of the attitude control of the flight vehicle.

### SUMMARY OF THE INVENTION

An embodiment of the present invention is directed to providing a hybrid rocket using catalytic decomposition of an oxidizer, which is a catalytic ignition type in that an oxidizer is supplied through a catalytic part and high temperature oxygen mixture gas produced by decomposition in the process is injected to a solid fuel, and thus generates ignition and combustion only by supplying the oxidizer without a separate igniter and causes the combustion without fire.

To achieve the object of the present invention, the present invention provides a hybrid rocket using catalytic decomposition of an oxidizer, including: a liquid phase oxidizer (0); a solid phase fuel (100) formed with a combustion chamber in an inside thereof, the combustion chamber passing through the solid fuel from one side to the other side so as to allow the oxidizer (0) flowing therein; a catalytic reactor (200) filled with a catalyst (220) for catalytically reacting the oxidizer (0), and introducing the oxidizer (0) through one side thereof and discharging the oxidizer (0) catalytically reacted through the catalyst (220) through the other side thereof; a combustor (300) formed with a space for inserting the solid fuel (100) therein, and introducing high temperature oxygen and steam in an inside thereof through one side thereof connected with the other side of the catalytic reactor (200), reacting them with the solid fuel (100) and discharging a combustion gas through the other side thereof; and a nozzle (400) connected with the other side of the combustor (300) to accelerate the combustion gas produced in the combustor (300) and discharge the combustion gas to the other side of the nozzle (400).

Preferably, the oxidizer (0) is hydrogen peroxide (H₂O₂) or nitrogen dioxide (N₂O).

Preferably, the solid fuel (100) is one selected from the group consisting of paraffin, polyethylene (PE), polymethylmethacrylate (PMMA) and hydroxyl-terminated polybutadiene (HTPB).

Preferably, the catalyst (220) is one or more selected from the group consisting of platinum (Pt), silver (Ag), rhodium (Rh), ruthenium (Ru), manganese oxide (MnOx) and manganese-including composite metal oxide.

Preferably, the catalyst (220) is filled in a form of grain or screen.

Preferably, the combustor (300) includes a fuel case (310) for facilitating replacement of the solid fuel (100), in which the solid fuel (100) is inserted in the fuel case (310) and the fuel case (310) is inserted in the combustor (300).

Preferably, the hybrid rocket further includes an oxidizer supplying part (500) connected with one side of the catalytic reactor (200) and formed with an oxidizer supplying hole (510) for supplying the oxidizer (0) to the catalytic reactor (200) in the other side of oxidizer supplying part (500).

In accordance with the present invention, the system is simplified since ignition and combustion are generated only by supplying of the oxidizer, re-ignition is enabled since the combustion is caused without an igniter, and quick ignition at a desired time point is possible since the ignition is generated simultaneously with the supply of the oxidizer. Also, possibility of unstable combustion is reduced since the oxidizer 0 is injected in a form of high temperature oxygen gas.

### BRIEF DESCRIPTION OF THE DRAWINGS

FIG. 1 is a perspective view illustrating a hybrid rocket in accordance with an embodiment of the present invention.

FIG. 2 is an exploded perspective view illustrating a hybrid rocket in accordance with an embodiment of the present invention.

FIG. 3 is a sectional view illustrating a hybrid rocket in accordance with an embodiment of the present invention.

FIG. 4 is graphs illustrating thrust with time in a continuous operation mode and a pulse operation mode of a rocket.

### DETAILED DESCRIPTION OF MAIN ELEMENTS

| | |
|---|---|
| 0: oxidizer | |
| 100: solid fuel | |
| 200: catalytic reactor | 210: injector |
| 220: catalyst | 230: discharge hole |
| 300: combustor | 310: fuel case |
| 320: gasket | 400: nozzle |
| 500: oxidizer supplying part | |
| 510: oxidizer supplying hole | |

### DESCRIPTION OF SPECIFIC EMBODIMENTS

The advantages, features and aspects of the invention will become apparent from the following description of the embodiments with reference to the accompanying drawings, which is set forth hereinafter.

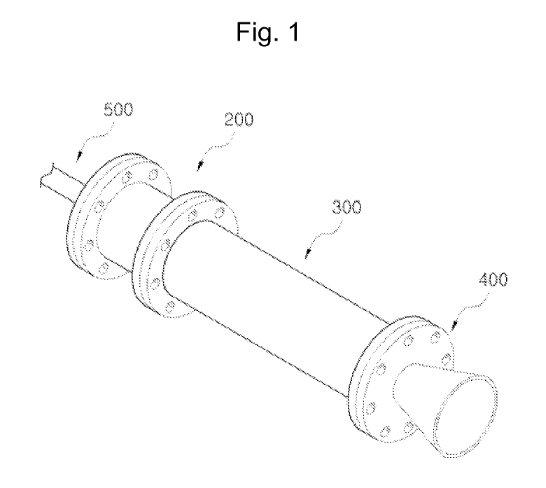

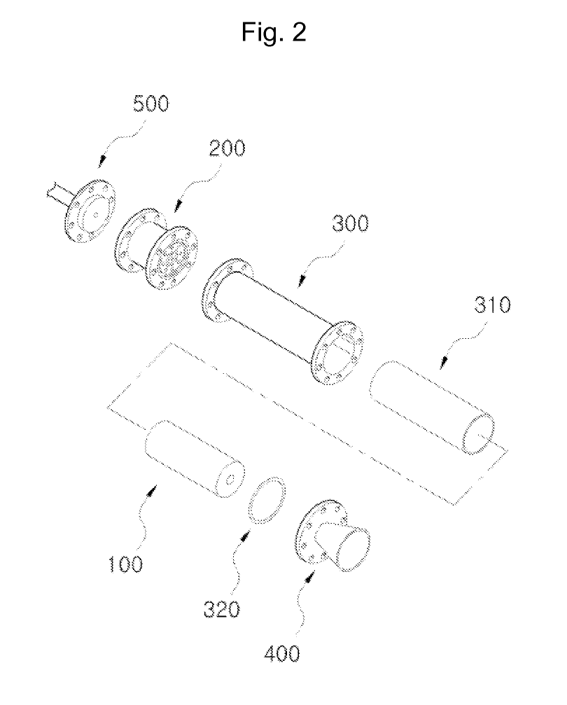

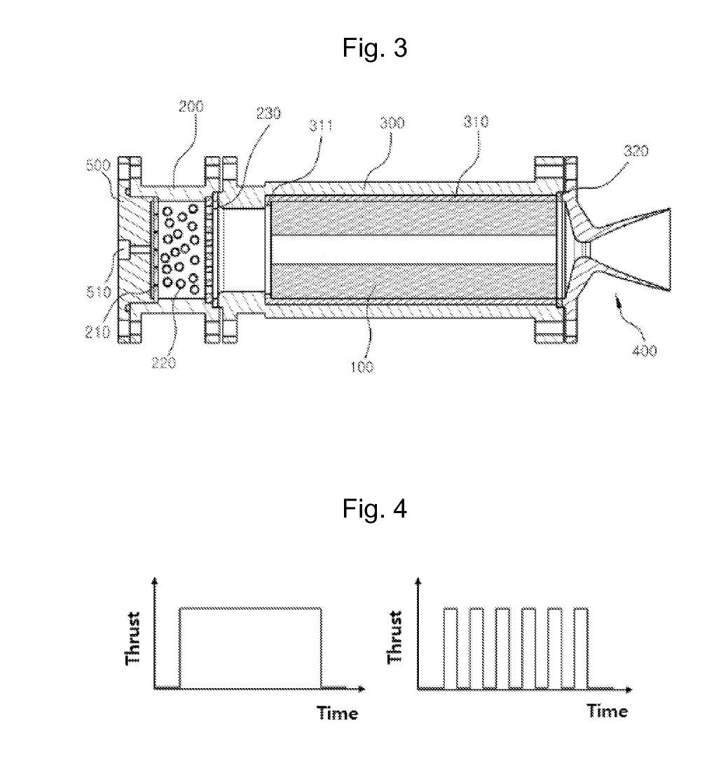

Referring to FIGS. 1 to 3, a hybrid rocket using catalytic decomposition of an oxidizer in accordance with an embodiment of the present invention includes an oxidizer supplying part 500 for supplying an oxidizer 0, a solid fuel 100, a catalytic reactor 200 for catalytically reacting the oxidizer 0, a combustor 300 for inserting the solid fuel 100 therein and reacting the solid fuel 100 and the oxidizer 0 to generate combustion gas, and a nozzle 400 for injecting the combustion gas.

The hybrid rocket using catalytic decomposition of an oxidizer in accordance with an embodiment of the present invention employs catalytic ignition method. The catalytic ignition method is the method of converting the oxidizer into high temperature oxygen mixed gas through catalytic reaction and injecting the high temperature oxygen mixed gas into the solid fuel. The supplied high temperature oxygen mixed gas induces auto ignition of the solid fuel.

The oxidizer 0 may be hydrogen peroxide (H₂O₂) or nitrogen dioxide (N₂O). The hydrogen peroxide should be the most suitable as the oxidizer 0 of the present invention since it is easily handled as it can be stored at room temperature, it non-toxic, and is simple and environment friendly as it is reacted to water and oxygen to generate heat when it comes in contact with the catalyst.

The hydrogen peroxide has a chemical formula of H₂O₂ and has one more oxygen atom than water. The hydrogen peroxide is colorless, odorless and easy water soluble liquid, and has been used as power source for various engines from 1930s since it generates chemical reaction as follows to produce a high temperature gas when it comes into contact with a catalyst.

The hydrogen peroxide reacts by the following chemical formula:

2H₂O₂(l)->2H₂O(g)+O₂(g)+Heat

The hydrogen peroxide advantages as follows.

(1) Excellent storability: since the hydrogen peroxide remains liquid state at a room temperature and can be stored for a long time in a suitable container, the hydrogen peroxide does not require heat insulation for a storage tank and pipes as is required in liquid oxygen.

(2) Non-toxic: unlike most of the storable fuels have strong toxicity that causes cancer, the hydrogen peroxide may be naturally reacted and produced in a respiratory organ of human being. It is such harmless to human body that hydrogen peroxide of 3% concentration is used as a disinfectant. It has very low influence on the surrounding environment since the vapor is hardly generated at a room temperature due to its very low vapor pressure and only required is sufficient ventilation, and it has no toxicity as the materials produced after the catalytic reaction are water and oxygen. No special equipment is required to handle it since it has no toxicity, and no special equipment to handle combustion products is also required, and it is therefore possible to develop the apparatus in a low cost.

(3) No reaction with atmosphere: since the hydrogen peroxide does not react with any component in the atmosphere, there occurs no particular problem even when air is introduced into the rocket that employs the hydrogen peroxide.

(4) High mixture ratio: when the hydrogen peroxide is used as an oxidizer, it has a mixture ratio relatively higher than other oxidizers for the same fuel (a mixture ratio of about 8 when 85% concentration is applied to kerosene). Since it has high density and high mixture ratio, it is possible to reduce the volume of the fuel tank and resultantly reduce weight of the storage tank.

Also, the nitrogen dioxide (N₂O) can also be used as the oxidizer 0 in the present invention since high temperature oxygen is produced even when the nitrogen dioxide is catalytic decomposed.

The oxidizer supplying part 500 may be formed to supply the oxidizer 0 to the catalytic reactor 200. The oxidizer supplying part 500 may be formed with an oxidizer supplying hole 510 at the other side thereof. The oxidizer supplying part 500 functions to supply the oxidizer 0 to the catalytic reactor 200 through the oxidizer supplying hole 510.

The catalytic reactor 200 may be formed in a cylindrical shape. One side of the catalytic reactor 200 may be connected to the oxidizer supplying part 500. The one side of the catalytic reactor 200 may be formed with an injector 210. The injector 210 functions to inject the oxidizer 0 supplied through the oxidizer supplying hole 510 of the oxidizer supplying part 500 into an inside of the catalytic reactor 200. The injector 210 may be formed in plural.

The inside of the catalytic reactor 200 may be filled with catalyst 220. The catalyst 220 functions to catalytically react the introduced oxidizer 0 to generate high temperature oxygen. The catalyst 220 may be one or more selected from the group consisting of noble metal catalysts including platinum (Pt), silver (Ag), rhodium (Rh) and ruthenium (Ru), and manganese oxide (MnOx) composite metal oxide and manganese including composite metal oxide. The catalyst 220 is filled in the inside of the catalytic reactor 200 in a form of grain or screen to enlarge an area of catalytic reaction with the introduced oxidizer 0, thereby capable of increasing an efficiency of the catalytic reaction.

Besides the aforementioned catalysts, the catalyst 220 may employ a catalyst that has excellent reactivity at a low temperature, and at the same time, high stability at a high temperature. By using the catalyst made of the aforementioned material, it is possible to enable non-preheat start, stable lift-time performance and endurance at a catalytic reaction temperature of the high concentration oxidizer 0. To enlarge the catalytic reaction area, the catalyst 220 may be filled with being coated on a catalyst support, such as alumina (Al₂O₃), silica (SiO₂) and titania (TiO₂), formed with micropores.

The other side of the catalytic reactor 200 may be formed with a discharge hole 230 for discharging high temperature oxygen gas produced through the catalytic reaction. The discharge hole 230 may be formed in plural in a shape of a through hole.

Since the high temperature oxygen gas discharged through the catalytic reactor 200 has an adiabatic decomposition temperature higher than an ignition temperature of the fuel and thus enables ignition and combustion of the fuel without a separate igniter, the structure of the rocket is simplified. Also, re-ignition is enabled since the combustion is caused without an igniter, and quick ignition at a desired time point is enabled since the ignition is generated simultaneously with the supply of the oxidizer 0. Further, possibility of unstable combustion is reduced since the oxidizer 0 is injected in a form of high temperature oxygen gas.

The combustor 300 may be formed in a cylindrical shape with both sides being open. One side of the combustor 300 may be connected with the other side of the catalytic reactor 200. The combustor 300 introduces the high temperature oxygen gas discharged through the discharge hole 230 therein. The solid fuel 100 may be inserted in an inside of the combustor 300. In the inside of the combustor 300, the introduced high temperature oxygen gas and the solid fuel 100 are reacted to carry out ignition and combustion, and the combustion gas generated at this time is discharged through the other side.

The combustor 300 may be provided with a fuel case 310. The fuel case 310 may be formed in a cylindrical shape with both sides being open. The solid fuel 100 is inserted in the inside of the fuel case 310, and the fuel case 310 is inserted in the inside of the combustor 300. One side of the fuel case 310 is formed with a hump 311 which extends to a predetermined distance towards the center of the case 310 so as to fix the solid fuel 100. Since the solid fuel 100 is not mounted directly to the combustor 300 but is mounted to the combustor 300 with interposition of the fuel case 310 therebetween, the fuel case 310 may be provided so as to facilitate replacement of the fuel if it is employed in a re-usable rocket.

The solid fuel 100 may be formed in a cylindrical shape. The solid fuel 100 may be inserted in the fuel case 310 in a longitudinal direction. The solid fuel 100 is mounted in the inside of the combustor 300 as the fuel case 310 is mounted in the combustor 300. The solid fuel 100 may be formed with a combustion chamber that passes through the centers of both sides. The high temperature oxygen gas flows in the inside of the combustion chamber and reacts with the solid fuel 100 to thereby carry out ignition and combustion. An example of the solid fuel 100 may include paraffin, polyethylene, polymethylmethacrylate (PMMA) and hydroxyl-terminated polybutadiene (HTPB).

One side of the nozzle 400 may be connected to the other side of the combustor 300. The connection part between the nozzle 400 and the combustor 300 may be provided with a gasket 320. The gasket 320 has a ring shape and may be made of metal material. The gasket may be formed in order to prevent the combustion gas since the combustion gas is at high pressure and high temperature. The nozzle 400 functions to discharge the combustion gas generated in the combustor 300 to the other side to generate thrust. The nozzle 400 may be formed so that its sectional area is increased as goes to the other side. This is for injecting the combustor gas at a supersonic speed by accelerating the combustion gas.

While the present invention has been described with respect to the specific embodiments, it will be apparent to those skilled in the art that various changes and modifications may be made without departing from the spirit and scope of the invention as defined in the following claims.

What is claimed is:

1. A hybrid rocket using catalytic decomposition of an oxidizer, comprising:
a liquid phase oxidizer (0);
a solid phase fuel (100) formed with a combustion chamber in an inside thereof, the combustion chamber passing through the solid fuel from one side to the other side so as to allow the oxidizer (0) flowing therein;
a catalytic reactor (200) filled with a catalyst (220) for catalytically reacting the oxidizer (0), and introducing the oxidizer (0) through one side thereof and discharging the oxidizer (0) catalytically reacted through the catalyst (220) through the other side thereof;
a combustor (300) formed with a space for inserting the solid fuel (100) therein, and introducing high temperature oxygen and steam in an inside thereof through one side thereof connected with the other side of the catalytic reactor (200), reacting them with the solid fuel (100) and discharging a combustion gas through the other side thereof; and
a nozzle (400) connected with the other side of the combustor (300) to accelerate the combustion gas produced in the combustor (300) and discharge the combustion gas to the other side of the nozzle (400).

2. The hybrid rocket of claim 1, wherein the oxidizer (0) is hydrogen peroxide (H₂O₂) or nitrogen dioxide (N₂O).

3. The hybrid rocket of claim 1, wherein the solid fuel (100) is one selected from the group consisting of paraffin, polyethylene (PE), polymethylmethacrylate (PMMA) and hydroxyl-terminated polybutadiene (HTPB).

4. The hybrid rocket of claim 1, wherein the catalyst (220) is one or more selected from the group consisting of platinum (Pt), silver (Ag), rhodium (Rh), ruthenium (Ru), manganese oxide (MnOx) and manganese-including composite metal oxide.

5. The hybrid rocket of claim 1, wherein the catalyst (220) is filled in a form of grain or screen.

6. The hybrid rocket of claim 1, wherein the combustor (300) includes a fuel case (310) for facilitating replacement of the solid fuel (100), in which the solid fuel (100) is inserted in the fuel case (310) and the fuel case (310) is inserted in the combustor (300).

7. The hybrid rocket of claim 1, further comprising:
an oxidizer supplying part (500) connected with one side of the catalytic reactor (200) and formed with an oxidizer supplying hole (510) for supplying the oxidizer (0) to the catalytic reactor (200) in the other side of oxidizer supplying part (500).
